(19) United States
(12) Patent Application Publication
(10) Pub. No.: US 2023/0088010 A1
(43) Pub. Date: Mar. 23, 2023

(54) A MULTILAYER LIDDING FILM BASED ON POLYETHYLENE

(71) Applicant: Ecoflexibles Limited, Daventry Northamptonshire (GB)

(72) Inventors: Matthew Roy Francklow, Northampton (GB); Simon Derek Buswell, Northampton (GB)

(73) Assignee: Ecoflexibles Limited, Daventry Northamptonshire (GB)

(21) Appl. No.: 17/293,278

(22) PCT Filed: Nov. 12, 2019
(86) PCT No.: PCT/GB2019/053208

§ 371 Date: Oct. 12, 2021

(30) Foreign Application Priority Data
Nov. 12, 2018 (GB) 1818422.6

(51) Int. Cl. B32B 27/08; B32B 27/32; B32B 7/12; B32B 27/18; B32B 27/30; B65D 77/20; B65D 65/40; B32B 37/12; B32B 37/24; B32B 7/03

(52) U.S. Cl. CPC B32B 27/08; B32B 27/32; B32B 7/12; B32B 27/18; B32B 27/306; B65D 77/2024; B65D 65/40; B32B 37/12; B32B 37/24; B32B 7/03; B32B 2435/02; B32B 2270/00; B32B 2307/518; B32B 2307/516; B32B 2307/4023; B32B 2255/10; B32B 2307/7242; B32B 2255/20; B32B 2037/243; B32B 2323/04; B32B 2250/242; B32B 2439/70; B32B 2307/422; B32B 2307/71

(57) ABSTRACT

A lidding film comprising oriented polyethylene bonded to non-oriented polyethylene is disclosed. The oriented polyethylene may comprise a plurality of layers and the non-oriented polyethylene may comprise a plurality of layers, wherein the oriented polyethylene is bonded to the non-oriented polyethylene by extrusion coating or by a laminating adhesive. The oriented polyethylene comprises machine direction oriented polyethylene (MDO PE) or biaxially oriented polyethylene (BOPE). The lidding film may comprise from 1 to 15 wt. % of a polymer other than polyethylene, preferably the lidding film comprises no more than 5 wt. % of a polymer other than polyethylene. Also disclosed is a sealed container comprising a lidding film according to the invention and a polymer tray wherein the lidding film is heat sealed to the top edge of the polymer tray via the non-oriented polyethylene, thereby enclosing a product within a recess defined by the polymer tray. Also disclosed is a method of producing a lidding film.

The present invention relates generally to a lidding film, and more particularly to a lidding film comprising an oriented polyethylene and a non-oriented polyethylene.

### BACKGROUND

Lidding films are used in packaging applications, particularly in the food and drink and medical industries. Such lidding films are typically heat sealed to a tray, in order to enclose a product within a recess defined by the tray.

In the food and drink and medical industries in particular, it may be necessary to provide a controlled environment for the product enclosed within the sealed container. In these cases the lidding film must have specific barrier properties.

Lidding film is often a laminated construction, possibly comprising individual layers consisting of one or multiple of: metal foil, polymeric materials and/or paper. At the very least, such laminated lidding films will require a material suitable to heat seal the lidding film to the particular tray used, and a substrate material that provides mechanical properties such as rigidity, heat resistance and resistance to tear and puncture. Often the heat seal material may also provide specific barrier properties. The substrate material may also provide suitable printing properties.

A substrate material for such a lidding film would typically comprise polyester, nylon or polypropylene, as these materials offer good clarity, rigidity, and heat resistance.

The material used to heat seal the lidding film must soften during the heat sealing process so as to allow adequate wetting for the lidding film to adhere to the surface of the tray to which it is being bonded. Polymers are commonly used. The heat seal bond is effected by heating the polymer, and optionally applying pressure, without melting, or otherwise affecting the structure or compromising the structural integrity of, the substrate material. Thus, the polymer of the heat seal material should begin to soften at a temperature that is less than the melting temperature of the substrate material. Commonly, low-density polyethylene (LDPE) is used as the heat seal material.

The result of the above considerations is that manufacture of lidding films often relies on lamination of polyester, nylon, or polypropylene to polyethylene.

However, polyethylene to non-polyethylene lamination is problematic for recycling, since the non-polyethylene constituent will typically not be compatible with conventional and widespread treatments for the recovery of polyethylene from recycled material.

Whilst potential delamination processes have been explored for the separation of non-compatible materials in plastic film, such processes are currently too costly for widespread implementation, and as a result, it is estimated that some 1.2 million tonnes of plastic film from packaging arises in the UK waste stream every year.

As society's awareness of the importance of recycling increases, in particular the recycling of synthetic polymer-based materials, a new solution to the recycling of laminated multilayer lidding film is clearly pertinent.

### SUMMARY

The present invention provides a lidding film comprising a) oriented polyethylene bonded to b) non-oriented polyethylene, wherein a) the oriented polyethylene may comprise a plurality of layers and b) the non-oriented polyethylene may comprise a plurality of layers, and wherein a) the oriented polyethylene is bonded to b) the non-oriented polyethylene by extrusion coating or by c) a laminating adhesive.

The term “lidding film” as used herein describes a flat, flexible piece of material for use as a closure on a package comprising a tray. The term “tray” is used herein to describe any receptacle or means for holding a product, the tray having a top edge, and the tray also defining a recess within which a product may be received.

Preferably the lidding film comprises from 1 to 15 wt. % of a polymer other than polyethylene. More preferably the lidding film comprises no more than 5 wt. % of a polymer other than polyethylene, which enables the lidding film to conform to On-Pack Recycling Label guidelines. The lower the proportion of a polymer other than polyethylene, the easier it is to recycle the lidding film since the lidding film may then be treated according to substantially the same recycling process as materials made entirely from polyethylene. This avoids separation processes, for example delamination processes, that are otherwise required to separate incompatible materials to allow recovery of polyethylene.

Since extrusion coating uses polyethylene to bond a) the oriented polyethylene to b) the non-oriented polyethylene, lidding films in accordance with the invention that have been bonded by extrusion coating may be readily recycled. Furthermore, lidding films in accordance with the invention that have been bonded by extrusion coating may comprise little or no materials other than polyethylene or consist essentially of polyethylene.

Lidding films in accordance with the invention that have been bonded using c) a laminating adhesive are advantageous due to ease of manufacture and the associated cost benefits.

Any suitable form of oriented polyethylene may be used in the lidding film of the present invention. For example, the oriented polyethylene may comprise machine direction oriented polyethylene (MDO PE) or biaxially oriented polyethylene (BOPE).

In embodiments in which the lidding film comprises a laminating adhesive, the laminating adhesive may comprise a solids based polyurethane adhesive, a solvent based polyurethane adhesive or other suitable adhesives as known in the art.

Ink is commonly applied to lidding films. The ink may be applied to form a “reverse print” or a “surface print”. If a) the MDO polyethylene has a first surface and a second surface, an ink may be applied to the first surface of a) the MDO polyethylene.

In “reverse print” lidding films bonded by extrusion coating, the ink is in contact with both the first surface of a) the oriented polyethylene and a surface of b) the non-oriented polyethylene. This effectively interposes the ink between a) the oriented polyethylene and b) the non-oriented polyethylene. In “reverse print” lidding films bonded by c) a laminating adhesive, c) the laminating adhesive is interfaced with the first surface of a) the oriented polyethylene such that the ink is in contact with c) the laminating adhesive. This effectively interposes c) the laminating adhesive and the ink between a) the oriented polyethylene and b) the non-oriented polyethylene.

In “surface print” lidding films bonded by extrusion coating, the ink is not in contact with a surface of b) the non-oriented polyethylene and hence the ink is not interposed between a) the oriented polyethylene and b) the non-oriented polyethylene. In “surface print” lidding films bonded by c) a laminating adhesive, c) the laminating adhesive is interfaced with the second surface of a) the oriented polyethylene such that the ink is not contact with c) the laminating adhesive. This effectively interposes c) the laminating adhesive between a) the oriented polyethylene and b) the non-oriented polyethylene but does not interpose the ink between a) the oriented polyethylene and b) the non-oriented polyethylene.

If ink is applied to a lidding film as a “surface print” it may be washed off or otherwise removed during recycling. This may be advantageous since it may enable a clear or colourless film to be recycled and clear or colourless films are more desirable than opaque or coloured films.

The lidding film may additionally comprise a lacquer. The lacquer may be applied to a surface of the lidding film that will be exposed during any or all of transportation, storage, or use. In this way, the lacquer may prevent damage to the surface of the lidding film thereby acting as a protective lacquer. In “surface print” lidding films, the lacquer may prevent migration of the ink. For example, the lacquer may prevent scuffing of the ink when an exposed surface of the lidding film is contacted. The lacquer may allow the addition of a layer of material with a higher heat resistance (relative to the heat resistance of the lidding film in the absence of the lacquer and additional material). The lacquer may help heat transfer from the plurality of layers of oriented polyethylene to the plurality of layers of non-oriented polyethylene, which may help seal the lidding film to a tray whilst maintaining the structural integrity of the oriented polyethylene and thereby strengthening the lidding film. Moreover, the lacquer may enable the addition of silicone and/or wax, which silicone and/or wax facilitates the release of the lidding film from the apparatus used to form a seal between the lidding film and a tray to which it is being sealed.

To allow the lidding film to provide a controlled environment for a product enclosed within a sealed container, the lidding film may comprise additives or coatings.

Optionally, b) the non-oriented polyethylene comprises one or more additives, optionally selected from a gas barrier, a UV filter and an anti-fogging additive.

The gas barrier may be in the form of a separate layer with tie layers being used to bond the gas barrier layer to non-oriented polyethylene layers. The gas barrier may comprise an ethylene-vinyl alcohol (EVOH) copolymer or other suitable gas barriers as known in the art. Tie layers typically comprise functionalised polymers, with the type of functionalised polymers used depending on the materials to be bonded and on the desired strength of the bond formed, both of which will depend on the intended application of the product comprising the tie layer. Examples of functionalised polymers that may be used as tie layers include ethylene vinyl acetate (EVA), ethylene methyl acrylate (EMA), ethylene acrylic acid (EAA) and ethylene methacrylic acid (EMAA). EMAA is suitable for use in bonding polyethylene to EVOH, hence the tie layers used in the present invention may comprise EMAA or other suitable materials as known in the art. Dow's AMPLIFY™ TY functional polymers comprise EMAA.

The UV filter may be combined with non-oriented polyethylene to form a mixed UV filter/non-oriented polyethylene layer. The UV filter may comprise a sorbitan ester or other suitable UV filters as known in the art.

The anti-fogging additive may be combined with non-oriented polyethylene to form a mixed anti-fogging additive/non-oriented polyethylene layer. The anti-fogging additive may comprise a fluorescent whitening agent or other suitable anti-fogging additives as known in the art.

The UV filter and the anti-fogging additive may be combined with non-oriented polyethylene to form a mixed UV filter/anti-fogging additive/non-oriented polyethylene layer.

In some applications it may be desirable for a consumer to be able to substantially reseal the lidding film to a tray after the lidding film is initially peeled off the tray, for example to protect a product received within the tray from the environment between subsequent uses of the product. For such applications, the plurality of layers of b) the non-oriented polyethylene may comprise at least three layers: two layers of non-oriented polyethylene and a layer of pressure-sensitive adhesive interposed between the two non-oriented polyethylene layers. The pressure-sensitive adhesive is known as a re-close adhesive. Suitable re-close adhesives include hot melt pressure sensitive adhesives, such as Bostik Thermogrip® M651.

It may be desirable to include a coating of a gas barrier material in addition to or instead of a gas barrier additive. In such lidding films, a) the oriented polyethylene is coated with a gas barrier material. The gas barrier material may comprise aluminium oxide or silicon oxide.

Depending on the intended application, the thickness of a) the oriented polyethylene may be from 10 to 35 μm. Furthermore, a) the oriented polyethylene may comprise from 3 to 10 layers, wherein each of the layers comprises oriented polyethylene. Typically, a) the oriented polyethylene comprises high-density polyethylene (HDPE).

Oriented polyethylene is polyethylene in which substantially all of the polyethylene chains are substantially aligned along the machine direction. As the skilled person would be aware, the dimensions of a polymeric film are defined in terms of the “machine direction” and the “transverse direction”, which correspond to the axes of the film production apparatus. The machine direction is the direction of travel along the film production line and corresponds to the length dimension of the film.

In embodiments in which the oriented polyethylene comprises MDO PE, each of the layers of MDO polyethylene may be produced by hot-stretching a layer of polyethylene in the machine direction at a ratio of at least 2:1 at a temperature above the softening point but below the melting point of the polyethylene. More preferably, the layer may be hot stretched at a stretch ratio of from 2:1 to 12:1. Stretching may be performed by numerous techniques known in the art such as by a blown, cast, or tenter process. After the layer has been hot stretched, it is generally passed over annealing rolls where the layer is annealed or heat-set at temperatures in the range of from about 50° C., and more often from about 100° C. to about 150° C., followed by cooling.

In embodiments in which the oriented polyethylene comprises BOPE, each of the layers of BO polyethylene may be produced using a two-step hot-stretching process or a one-step hot-stretching process. The two-step process comprises hot-stretching a layer of polyethylene in the machine direction to form MDO PE (as described above) and then hot-stretching the MDO PE using a tenter frame. The one-step process comprises hot-stretching a layer of polyethylene using a tenter frame and accelerating clips so that the layer of polyethylene is stretched in both the machine direction and the transverse direction at the same time. After the layer of polyethylene has been hot-stretched, it will be annealed and cooled as described above.

“Non-oriented polyethylene” is used herein to describe polyethylene in which there is not substantial orientation of substantially all of the polyethylene chains along the machine direction. Such polyethylene may be produced using a blown coextrusion process. Typically, b) the non-oriented polyethylene comprises low-density polyethylene (LDPE).

The non-oriented polyethylene softens during heat sealing such that it is suitable to form a bond of desired strength to a surface, such as a surface of a tray. The desired strength of the bond depends on the particular intended application of the lidding film. For example, where the lidding film is to be used in disposable packaging as closure for a tray, it is often intended that the packaged contents be sealed within the tray until a consumer wishes to access said product. The desired strength in this case would be for the seal to be strong enough to resist forces applied incidentally during subsequent processing, storage or transport, but not so strong that a consumer is unable to easily peel the lidding film from the tray when it is desired to access the packaged product.

Alternatively, other lidding films may be intended to be sealed to trays containing products where it is desired to prevent access to the product. In such a case the desired strength would be that which allowed the seal to resist forces arising from any foreseeable event, for example accidental impact during transport or storage, or deliberate tampering.

The lidding film of the present invention may be heat sealed to the top edge of a tray so as to enclose a recess of the tray between the tray and the lidding film. The lidding film may be sealed to the top edge of the tray by placing the lidding film in contact with the top edge of the tray such that the polyethylene heat seal laminate is in contact with the top edge of the tray and heating the lidding film such that the polyethylene heat seal laminate softens and wets a surface of the top edge of the tray sufficiently to form a bond of desirable strength. Optionally pressure may also be applied simultaneously with heating the lidding film during heat sealing.

Depending on the intended application, the thickness of b) the non-oriented polyethylene may be from 15 to 100 μm. Furthermore, b) the non-oriented polyethylene may comprise from 5 to 11 layers, wherein at least two of the layers comprise non-oriented polyethylene. For example, b) the non-oriented polyethylene may comprise 7 layers: an 8 μm non-oriented polyethylene, a 5 μm non-oriented polyethylene layer, a 3 μm tie layer, a 3 μm gas barrier layer, a 3 μm tie layer, a 5 μm non-oriented polyethylene layer and an 8 μm non-oriented polyethylene layer.

The present invention enables the combination of oriented polyethylene and oriented polyethylene to form lidding films that may be used for a variety of applications including lidding trays containing cheese, protein, fish and fresh produce. Lidding films comprising a gas barrier, a UV filter and/or an anti-fogging additive may be used to extend the shelf-life and/or protect the product enclosed within a tray thereby reducing food waste and hence reducing the carbon footprint of food production. Lidding films comprising ink (in the form of a “reverse print” or a “surface print”) reduce the need for labels to be applied to lidding films or the need for secondary packaging, which in turn reduces the quantity of packaging needing to be recycled or otherwise disposed of.

The present invention also provides a sealed container comprising:
the lidding film according to the present invention; and
a polymer tray having a top edge, the polymer tray defining a recess;
   wherein the lidding film is heat sealed to the top edge of the polymer tray via the non-oriented polyethylene, thereby enclosing a product within the recess.

Furthermore, the present invention provides a method of producing a lidding film according to the invention comprising
(i) bonding a) an oriented polyethylene to b) a non-oriented polyethylene by melting polyethylene and forming it into a thin film of b) non-oriented polyethylene, coating the thin film of b) non-oriented polyethylene onto a) oriented polyethylene, and pressing the b) non-oriented polyethylene onto the coated a) oriented polyethylene; or
(ii) bonding a) an oriented polyethylene to b) a non-oriented polyethylene using c) a laminating adhesive.

Bonding a) the oriented polyethylene to b) the non-oriented polyethylene may comprise heating a) the oriented polyethylene and/or b) the non-oriented polyethylene when a) the oriented polyethylene and b) the non-oriented polyethylene are in contact.

The method of producing a lidding film according to the present invention may comprise coating a) the oriented polyethylene with a gas barrier material, optionally wherein the gas barrier material comprises aluminium oxide or silicon oxide.

### FIGURES

FIG. 1 is a cross-sectional view of a lidding film according to the present invention.

FIG. 2A is a cross-sectional view of a lidding film according to the present invention in which ink has been applied to a first surface of the oriented polyethylene, such that the ink is in contact with the laminating adhesive, according to a “reverse print” arrangement.

FIG. 2B is a cross-sectional view of an a lidding film according to the present invention in which ink has been applied to a first surface of the oriented polyethylene, such that the ink is not in contact with the laminating adhesive, according to a “surface print” arrangement.

FIG. 3 shows the lidding film heat sealed to a tray.

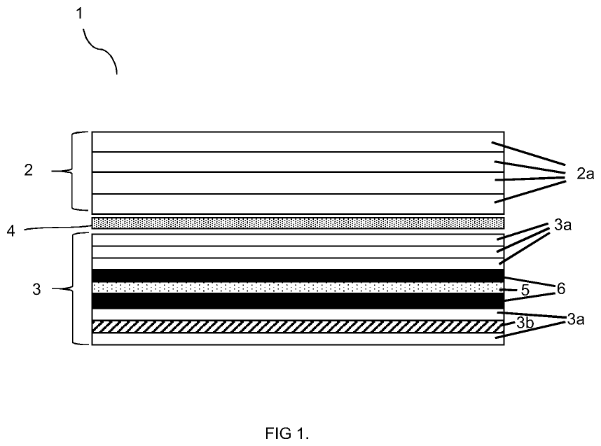

FIG. 1 shows a lidding film (1) comprising a) oriented polyethylene (2) bonded to b) non-oriented polyethylene (3) by c) laminating adhesive (4). The oriented polyethylene comprises a plurality of layers (2a) and b) the non-oriented polyethylene comprises a plurality of layers (3a, 3b, 5 and 6). In FIG. 1 the oriented polyethylene comprises 4 layers of oriented polyethylene (2a), 6 layers of non-oriented polyethylene (3a, 3b), a layer of a gas barrier (5) and two tie layers (6). One of the layers of non-oriented polyethylene (3b) is a UV filter/anti-fogging additive/non-oriented polyethylene layer. The numbers of layers and/or the combinations of additives may be varied depending on the intended application of the lidding film (1).

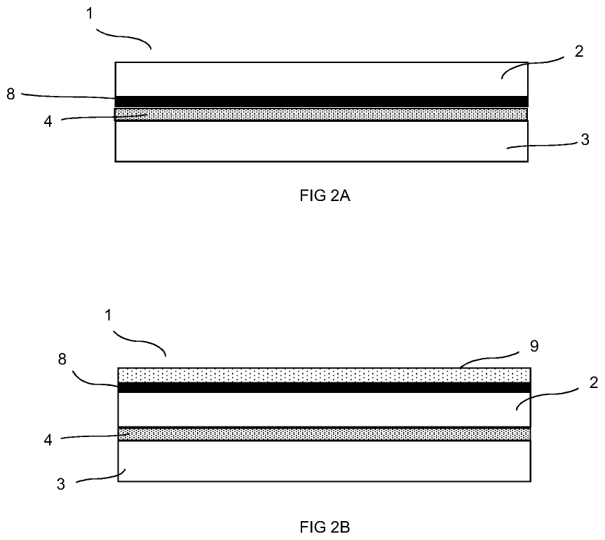

FIG. 2A shows a lidding film in which ink (8) has been applied to a first surface of a) the oriented polyethylene (2), such that the ink is in contact with the laminating adhesive (4), according to a “reverse print” arrangement. Please note that the ink (8) may or may not form a continuous layer.

FIG. 2B shows a lidding film in which ink (8) has been applied to a first surface of a) the oriented polyethylene (2), such that the ink (8) is not in contact with the laminating adhesive (4), according to a “surface print” arrangement. Please note that the ink (8) may or may not form a continuous layer. The “surface print” lidding film also includes a lacquer (9) to help prevent migration of the ink (8).

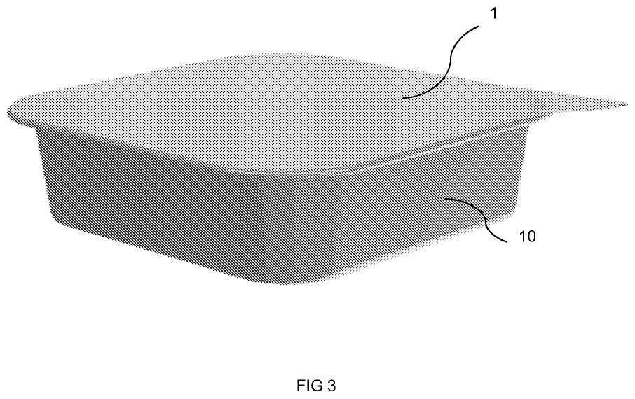

FIG. 3 shows the lidding film (1) of the present invention heat sealed to a tray (10). A food product such as meat or cheese may be enclosed within the lidding film (1) and tray (10).

1. A lidding film comprising a) oriented polyethylene bonded to b) non-oriented polyethylene, wherein a) the oriented polyethylene may comprise a plurality of layers and b) the non-oriented polyethylene may comprise a plurality of layers, and wherein a) the oriented polyethylene is bonded to b) the non-oriented polyethylene by extrusion coating or by c) a laminating adhesive.

2. A lidding film as claimed in claim 1, wherein the lidding film comprises from 1 to 15 wt. % of a polymer other than polyethylene, preferably wherein the lidding film comprises no more than 5 wt. % of a polymer other than polyethylene.

3. A lidding film as claimed in claim 1, wherein the oriented polyethylene comprises machine direction oriented polyethylene (MDO PE) or biaxially oriented polyethylene (BOPE).

4. A lidding film as claimed in claim 1, wherein the laminating adhesive comprises a solids based polyurethane adhesive or a solvent based polyurethane adhesive.

5. A lidding film as claimed in claim 1, wherein a) the oriented polyethylene has a first surface and a second surface, and wherein the lidding film comprises an ink applied to the first surface of a) the oriented polyethylene.

6. A lidding film as claimed in claim 5, wherein
(i) the lidding film is bonded by extrusion coating and the ink is in contact with both the first surface of a) the oriented polyethylene and a surface of b) the non-oriented polyethylene; or
(ii) the lidding film is bonded by c) a laminating adhesive, and c) the laminating adhesive is interfaced with the first surface of a) the oriented polyethylene such that the ink is in contact with c) the laminating adhesive.

7. A lidding film as claimed in claim 5, wherein
(i) the lidding film is bonded by extrusion coating and the ink is not in contact with a surface of b) the non-oriented polyethylene; or
(ii) the lidding film is bonded by c) a laminating adhesive, and c) the laminating adhesive is interfaced with the second surface of a) the MDO polyethylene such that the ink is not contact with c) the laminating adhesive.

8. A lidding film as claimed in claim 1, wherein the lidding film comprises a lacquer.

9. A lidding film as claimed in claim 1, wherein b) the non-oriented polyethylene comprises one or more additives, optionally selected from a gas barrier, a UV filter and an anti-fogging additive.

10. A lidding film as claimed in claim 9, wherein b) the non-oriented polyethylene comprises a gas barrier, and wherein the gas barrier comprises an ethylene-vinyl alcohol (EVOH) copolymer.

11. A lidding film as claimed in claim 10, wherein the gas barrier comprises EVOH interposed between tie layers, optionally wherein the tie layers comprise ethylene methacrylic acid.

12. A lidding film as claimed in claim 9, wherein b) the non-oriented polyethylene comprises a UV filter, and wherein the UV filter comprises a sorbitan ester.

13. A lidding film as claimed in claim 9, wherein b) the non-oriented polyethylene comprises an anti-fogging additive, and wherein the anti-fogging additive comprises a fluorescent whitening agent.

14. A lidding film as claimed in claim 1, wherein b) the non-oriented polyethylene comprises at least three layers: two layers of non-oriented polyethylene and a layer of pressure-sensitive adhesive interposed between the two non-oriented polyethylene layers.

15. A lidding film as claimed in claim 1, wherein a) the oriented polyethylene is coated with a gas barrier material, optionally wherein the gas barrier material comprises aluminium oxide or silicon oxide.

16. A lidding film as claimed in claim 1, wherein a) the oriented polyethylene comprises from 3 to 5 layers, and wherein each of the layers comprises oriented polyethylene.

17. A lidding film as claimed in claim 1, wherein b) the non-oriented polyethylene comprises from 5 to 11 layers, and wherein at least two of the layers comprise blown polyethylene.

18. A sealed container comprising:
the lidding film as claimed in any preceding claim;
a polymer tray having a top edge, the polymer tray defining a recess;
wherein the lidding film is heat sealed to the top edge of the polymer tray via the non-oriented polyethylene, thereby enclosing a product within the recess.

19. A method of producing a lidding film as claimed in claim 1, said method comprising
(i) bonding a) an oriented polyethylene to b) a non-oriented polyethylene by melting polyethylene and forming it into a thin film of b) non-oriented polyethylene, coating the thin film of b) non-oriented polyethylene onto a) oriented polyethylene, and pressing the b) non-oriented polyethylene onto the coated a) oriented polyethylene; or
(ii) bonding a) an oriented polyethylene to b) a non-oriented polyethylene using c) a laminating adhesive.

20. A method of producing a lidding film as claimed in claim 19, wherein bonding a) the oriented polyethylene to b) the non-oriented polyethylene comprises heating a) the oriented polyethylene and/or b) the non-oriented polyethylene when a) the oriented polyethylene and b) the non-oriented polyethylene are in contact.

21. A method of producing a lidding film as claimed in claim 19, comprising coating a) the oriented polyethylene with a gas barrier material, optionally wherein the gas barrier material comprises aluminium oxide or silicon oxide.
